(19) United States
(12) Patent Application Publication
(10) Pub. No.: US 2014/0109919 A1
(43) Pub. Date: Apr. 24, 2014

(54) Intraoral Discluding Appliance

(71) Applicant: Daniel K. Crout, Spartanburg, SC (US)

(72) Inventor: Daniel K. Crout, Spartanburg, SC (US)

(21) Appl. No.: 13/657,028

(22) Filed: Oct. 22, 2012

(51) Int. Cl. A61C 5/14

(52) U.S. Cl. 128/861

(57) ABSTRACT

An intraoral discluding appliance for the prevention of trauma and temporomandibular joint syndrome. The device is a small intraoral device that is custom made for each individual patient. The device includes two discluding elements over the cuspid areas known as cuspid pads. The device is inserted in the mouth and retained against the upper or lower anterior teeth. Typically, the device will be retained on the upper anterior teeth but occasionally mandible placement is necessary. As the mouth is closed, the discluding elements contact the opposing cuspids and prevent the posterior teeth from touching. This effectively reduces parafunctional temporal muscle activity, eliminates trauma, and prevents bruxism. The device is removable and may be worn full time, but is typically removed at least during meals and for cleaning. Additionally, the device may be worn only part time, for example it may be used as a bedtime appliance.

### BACKGROUND OF THE INVENTION

Improper positioning of the temporomandibular joint and associated musculature often causes various complications. One very common problem is teeth-grinding during sleep. However, the improper positioning can also lead to excessive wear of teeth, loose teeth, rotation and/or migration of teeth, cracked or broken teeth, headaches, joint pain, popping or clicking of the temporomandibular joint, deterioration of the joint. and other issues associated with the masticatory system.

All of the problems associated with the improper positioning of the temporomandibular joint occur when the posterior mandibular and maxillary teeth come into contact with each other. This contact is caused by the isometric contractions that occur when the temporalis muscle elevates the lower jaw. Ideally, this clenching (also called “bruxism”) only occurs while eating, but clenching often occurs inadvertently. Bruxism is a parafunctional activity and often occurs during sleep or when intensely concentrating on something.

A patient diagnosed with temporomandibular joint problems may be given one of several currently known devices, such as a full appliance, a mandibular advancement appliance, a nociceptor trigeminal inhibitor (“NTI”), a pivotal appliance, or a Eubank appliance (E-appliance).

These known devices do not adequately alleviate temporomandibular joint problems. Oral appliances are intended to eliminate or reduce trauma to our temporomandibular joint, jaw muscles, and teeth. However, ironically, every appliance that is currently on the market has a traumatic element built into it. Thus, while these oral appliances can help to alleviate some side effects associated with bruxism, they do not remedy the underlying problem and often cause additional complications.

Older appliances such as the orthotics or splints described by Norton in U.S. Pat. No. 4,671,766 and Sullivan in U.S. Pat. No. 4,519,386 are intended to reposition the jaw. However, they cover either the upper or lower posterior teeth and dictate jaw position by guiding the opposing jaw into normal position. Unfortunately, the upper and lower jaws are approximated by way of the splint, thus allowing the clenching to continue.

Devices such as the NTI, as described by Boyd in U.S. Pat. No. 5,795,150, were created to alleviate the problems created by these old splints. The NTI does in fact accomplish this goal. The NTI uses a single discluding element that is fitted over incisors and lands against opposing incisors. It minimizes the leveraging placed on teeth by the masseter and medial pterygoid muscles and eliminates proprioception firing of the molars and bicuspids preventing temporal muscle firing by relying solely on incisor function. However, the NTI suffers from three critical issues: (1) nociceptive inhibition is absent during sleep (when most people prefer to use the product), (2) tangling with the discluding element of the NTI (multiple appliances needed to accommodate problems), and (3) unnecessary lateral pterygoid or temporal muscle stimulation.

Another known solution, the E-appliance, as described by Eubank in U.S. Pat. No. 8,033,282 B2, suffers from a similar problem as the NTI. It too only contains a single discluding element. The E-appliance acts as a retainer and thus prevents teeth from ever reaching a neutral zone, making equilibration extremely difficult if not impossible to do correctly. The E-appliance uses a single bearing point (“stylus”) on one arch and a flat plate (“platform”) on the other. This requires full upper and lower appliances so the stylus can move freely on the incisal platform. Using two appliances can vertically extend the jaws far past the freeway space, and the closing muscles may react by contracting to regain their normal working length.

While the NTI and the E-appliance have been critical to advancing intraoral appliances, these devices are still inadequate and undesirable for many users. Both are these appliances are bulky, unaesthetic, and impinge on tongue space. Because of these shortcomings, patients often do not like using these devices during the day, which is when they are most effective. Additionally, these devices fail to adequately eliminate trauma to the temporomandibular joint. Therefore, there is a continuing need to create a more practical device to remedy bruxism.

### BRIEF SUMMARY OF THE INVENTION

The above mentioned problems will be alleviated with the disclosed device. The invention disclosed herein is an intraoral appliance which is a true neuromuscular appliance designed to reduce or eliminate most jaw-muscle activity, with the goal of allowing the condylar/disc relationship to seek its neutral and physiologic position. The disclosed appliance is a passive appliance for relaxing jaw muscles by preventing or minimizing their contraction while eliminating trauma to the temporomandibular joints. The inventive device disclosed herein also allows teeth not covered by the appliance to move freely to their neutral zone or balanced positions between each other, the jaw muscles, and the tongue.

The disclosed appliance fits within the freeway or resting space between the jaws. The opposing cuspids contact two cuspid pads of the disclosed appliance when loaded by muscular activity while the lower jaw's condyles are in their centric relation position. The discluding elements or cuspid pads are of a relatively low thickness as compared to the average adult freeway space (which is about 3 to 4 mm), such that the disclosed appliance is passive until needed. In one example embodiment, the thickness of the cuspid pads may be about 2 mm. The cuspids stay balanced on the cuspid pads when the condyles are protruded forward. Cuspids are in the densest bone of all teeth and have the most protective proprioceptive feedback of the brain. This provides an advantage over the prior art devices which rely on the incisors and concentrate all of the contact pressure on a single loading point. In contrast, the disclosed appliance distributes the bite pressure over multiple contact points and directs the pressure toward the strongest and least sensitive portions of the jaw and face.

### BRIEF DESCRIPTION OF THE DRAWINGS

For a more complete understanding of the present invention and advantages thereof, reference is now made to the following descriptions taken in conjunction with the accompanying drawings, in which:

FIG. 1 illustrates a front view of the disclosed passive appliance applied to the patient's maxillary teeth.

FIG. 2 illustrates an enlarged and focused front perspective view of the disclosed passive appliance applied to the patient's maxillary teeth.

FIG. 3 illustrates a bottom perspective view of the disclosed passive appliance applied to the patient's maxillary teeth.

FIG. 4 illustrates an enlarged bottom perspective view referencing the cuspid contact point and directions of protrusive and lateral movement on the disclosed passive appliance as applied to the patient's maxillary teeth.

FIG. 5 illustrates a front view of the disclosed passive appliance applied to the patient's mandibular teeth.

FIG. 6 illustrates an enlarged and focused perspective view of the disclosed passive applied to the patient's mandibular teeth.

FIG. 7 illustrates a top perspective view of the disclosed passive appliance applied to the patient's mandibular teeth.

FIG. 8 illustrates an enlarged top perspective view referencing the cuspid contact point and directions of protrusive and lateral movement on the disclosed passive appliance as applied to the patient's mandibular teeth

FIG. 9 is an enlarged section view, taken along line 9-9 of FIG. 1, illustrating the balanced cuspid contact point in protrusion of the disclosed passive appliance.

### DETAILED DESCRIPTION

The disclosed appliance will most often be placed in the maxillary arch, but in some cases, e.g. when the patient has an underbite, it will be more appropriately placed in the mandibular arch. In either case, the structure and function of the device itself is unchanged. In the foregoing description, it is to be understood that the term “opposing” refers to the arch which is not covered by the disclosed appliance. For example, the term “opposing cuspids” will in most cases refer to the mandibular cuspids when the disclosed appliance is placed in the maxillary arch, but it is also contemplated that the disclosed appliance may be disposed in the mandibular arch, in which case the “opposing cuspids” would be the maxillary cuspids. In either case, the function of the disclosed appliance is the same.

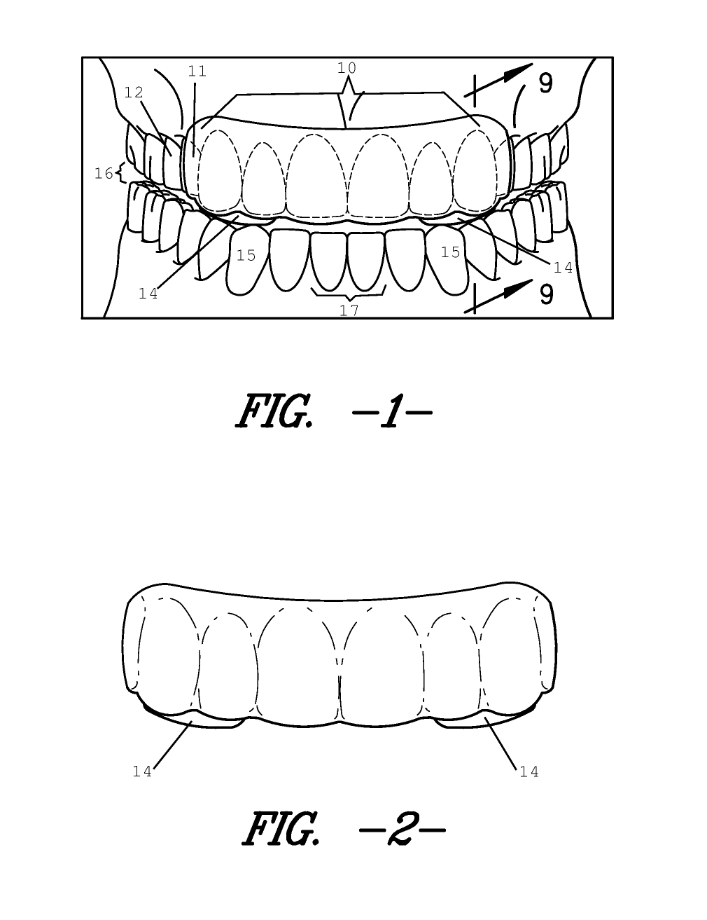

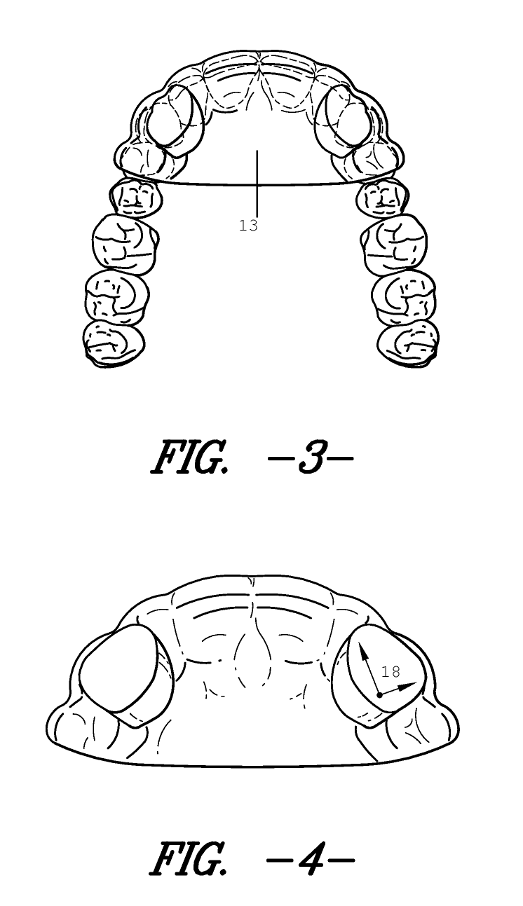

In the embodiment illustrated in FIGS. 1 & 5, when placed in either arch, the appliance will cover all anterior teeth 10 and the first bicuspid 11. However, it is also contemplated within the scope of the disclosed invention that the arcuate extent of the appliance may be greater or lesser when appropriate. In another example embodiment, the disclosed appliance can extend to encompass the second bicuspids 12 to provide extra retention. In the maxillary arch, it will cover most if not all the rugae area as well 13 (as detailed in FIG. 3). The contact points are two discluding elements over the covered cuspid areas known as cuspid pads 14. The opposing arch cuspids 15 should simultaneously contact the disclosed appliance on both cuspid pads 14 when both mandibular condyles are in their centric relation position. This cuspid contact should take place within the resting or freeway space 16. The disclosed appliance should fit passively (i.e., without bearing any load) within the freeway space while the jaw muscles are relaxed. The disclosed appliance will remain passive until the opposing cuspids load on it by muscular activity of the lower jaw such as in clenching (see, e.g., FIG. 9).

Referring again to the embodiment illustrated in FIGS. 1 & 5, with both mandibular condyles in their centric relation position, the contact position of both opposing cuspids simultaneously on the disclosed appliance represents a correct orthopedic relationship of the mandible to the rest of the head. From this position, the cuspids track bilaterally forward in protrusion until the incisors are edge to edge. The opposing central incisors 17 may or may not touch the disclosed appliance when edge to edge. In a Class 3 dental/skeletal relationship, the lower incisors are already edge to edge or anterior to the upper incisors. The disclosed appliance is more appropriately disposed in the mandibular arch in Class 3 situations since incisors separate from each other in protrusion.

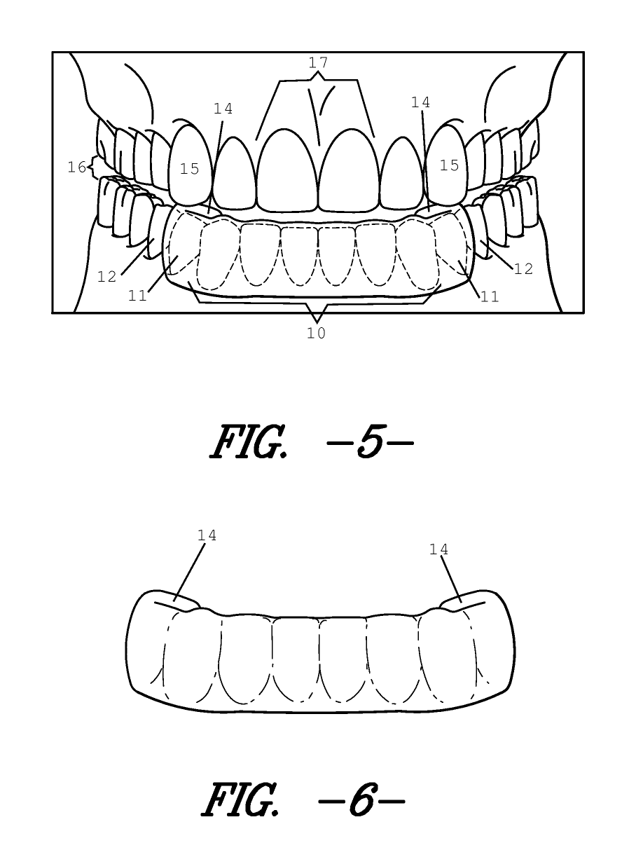

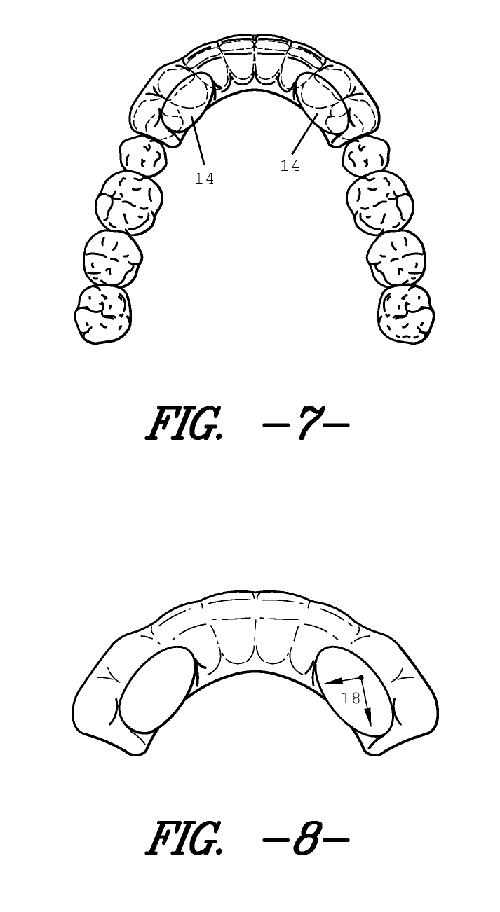

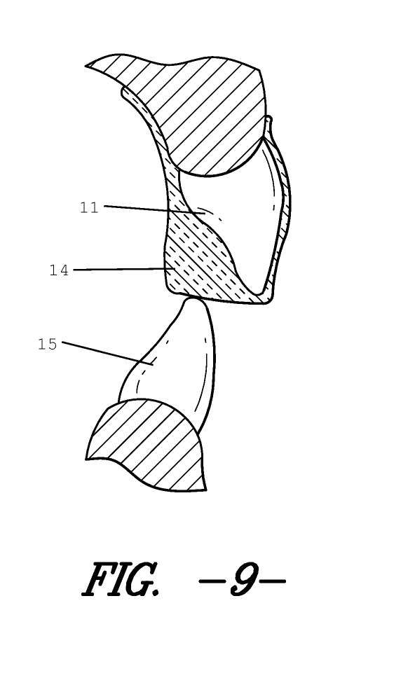

As shown in FIGS. 4 & 8, lateral movements (as shown by arrows 18) will also be made on the cuspid pads 14 from the centric relation jaw position. The cuspid pads 14 should be flat or nearly so to avoid isometric pressure while making protrusive and lateral movements. In a preferred embodiment, the cuspid pads 14 should be wide enough for 3 to 4 mm lateral tracking.

During protrusive and lateral movements, no posterior teeth (bicuspids and molars) should touch within the functioning range described.

When the opposing cuspids are shorter than their neighboring first bicuspids and lateral incisors, a second opposing appliance may be made to oppose the disclosed appliance. The purpose is to add enough material to increase the height of the depressed opposing cuspids so they can function properly against the disclosed appliance in centric, protrusive and lateral movements.

The use of the disclosed appliance prevents heavy loading of the temporomandibular joints since the temporal muscles are relaxed. In order for the very powerful temporal muscles to contract, the proprioceptive nerves around the roots of the posterior teeth must be stimulated by loading. Since the disclosed appliance does not allow loading of posterior teeth, there is no contraction except for some anterior fibers of the temporal muscle.

The masseter and medial pterygoid muscles work on command, unlike the reflex contraction of the temporal muscles. By landing on the cuspid pads far removed from the mandibular condyles and muscles, the mechanical advantage of the masseter and medial pterygoid muscles is significantly reduced (usually 70% or more). This prevents or lessens trauma to the temporomandibular joints while minimizing function and fatigue of these muscles.

The lateral pterygoid muscles protrude, and function to help open and laterally move the lower jaw. The cuspid pads or discluding elements are flat or nearly so in order for the cuspids opposing the disclosed appliance to move forward and laterally without isometric forces. The discluding elements 14 must be tall enough to prevent contact of the posterior teeth in protrusion and lateral movements. As a result, the lateral pterygoid muscles cannot fatigue even if bruxing is still present.

While preferred embodiments and example configurations have been shown and described, it is to be understood that various further modifications and additional configurations will be apparent to those skilled in the art. All such modifications and configurations are contemplated as being within the scope of the present invention. The specific embodiments and configurations disclosed are illustrative of the preferred and best modes for practicing the invention as defined by the appended claims, and should not be interpreted as limitations on the scope of the invention as defined by the appended claims. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

I claim:

1. An intraoral discluding appliance for reducing and preventing trauma in a patient's temporomandibular joint, comprising:
an arch configured to encompass at least a patient's maxillary anterior teeth;
a plurality of discluding elements arranged on said arch such that when said arch is applied over the patient's maxillary anterior teeth, the discluding elements proximately overlie the maxillary cuspids;
said discluding elements configured to engage the patient's mandibular cuspids in response to tension or clenching of the patient's jaw muscles; and
whereby tension in the jaw muscles and trauma to the temporomandibular joint is reduced or prevented.

2. The intraoral discluding appliance of claim 1, wherein said arch is configured to further encompass the patient's maxillary first bicuspids.

3. The intraoral discluding appliance of claim 2, wherein said arch is configured to further encompass the patient's maxillary second bicuspids.

4. The intraoral discluding appliance of claim 1, wherein said discluding elements are disposed within the patient's freeway space such that the intraoral discluding appliance is passive when the jaw muscles are relaxed.

5. An intraoral discluding appliance for reducing and preventing trauma in a patient's temporomandibular joint, comprising:
an arch configured to encompass at least a patient's mandibular anterior teeth;
a plurality of discluding elements arranged on said arch such that when said arch is applied over the patient's mandibular anterior teeth, the discluding elements proximately overlie the mandibular cuspids;
said discluding elements configured to engage the patient's maxillary cuspids in response to tension or clenching of the patient's jaw muscles; and
whereby tension in the jaw muscles and trauma to the temporomandibular joint is reduced or prevented.

6. The intraoral discluding appliance of claim 5, wherein said arch is configured to further encompass the patient's mandibular first bicuspids.

7. The intraoral discluding appliance of claim 6, wherein said arch is configured to further encompass the patient's mandibular second bicuspids.

8. The intraoral discluding appliance of claim 5, wherein said discluding elements are disposed within the patient's freeway space such that the intraoral discluding appliance is passive when the jaw muscles are relaxed.
